(19) United States
(12) Patent Application Publication
(10) Pub. No.: US 2017/0278385 A1
(43) Pub. Date: Sep. 28, 2017

(54) SMART WRISTBAND SAFETY WARNING SYSTEM

(71) Applicant: Shawn Robert Jevne, Swan Hills (CA)

(72) Inventor: Shawn Robert Jevne, Swan Hills (CA)

(21) Appl. No.: 15/079,673

(22) Filed: Mar. 24, 2016

(51) Int. Cl. G08G 1/005; G08B 25/01; G08B 21/02

(52) U.S. Cl. CPC G08G 1/005; G08B 21/02; G08B 25/016

(57) ABSTRACT

A pedestrian and worker safety system, comprising: a) at least one smart wristband unit; and b) one or more machines, vehicles and/or trains, each comprising i) a communication unit comprising a wireless transceiver capable of transmitting and/or receiving at least one warning information to/from at least one smart wristband unit; and ii) a warning display unit, wherein warning information is transmitted via wireless communication between one or more machines, vehicles and/or trains and at least one smart wristband unit.

### FIELD OF THE INVENTION

The present disclosure is in the field of pedestrian and worker wireless safety warning systems.

### BACKGROUND OF THE DISCLOSURE

Machines such as forklifts, front-end loaders, cranes, mining equipment, construction site vehicles and locomotives of all types allow workers to perform tasks that otherwise would not be capable of being done. While much effort has been spent in recent years attempting to provide radio and hard-wired safety systems that allow such machines to be operated safely at all times and in all working environments, it is well understood that the use of these types of machines has led to the injury and death of operators and others working in close proximity to the machines. In recognition of the safety hazards these types of machines present, attempts have been made to design safety alarm systems capable of providing some form of audible or visual warning signal to machine operators and other personnel working around these machines that would indicate when a potentially dangerous working condition exists. However, the warning systems that have been proposed and employed to date have not been fully suitable.

Therefore, there is a need for improved safety warning systems for pedestrians and workers that are nearby machines, vehicles and locomotives that are capable of providing an improved warning system to warn an individual of a potentially dangerous condition if within a certain proximity of the machine.

### SUMMARY OF THE INVENTION

A pedestrian and worker safety system, comprising: a) at least one smart wristband unit; and b) one or more machines, vehicles and/or trains, each comprising i) a communication unit comprising a wireless transceiver capable of transmitting and/or receiving at least one warning information to/from at least one smart wristband unit; and ii) a warning display unit, wherein warning information is transmitted via wireless communication between one or more machines, vehicles and/or trains and at least one smart wristband unit.

A method of improving pedestrian and worker safety comprising the pedestrian and worker safety system of claim 1, the method comprising: a) transmitting warning information from at least one smart wristband unit to at least one communication unit; b) receiving the warning information from step a) with the at least one communication unit; c) processing the received warning information from step b) with the at least one communication unit; d) transmitting warning information to an operator via a communication unit; e) transmitting warning information from the at least one communication unit to at least one smart wristband unit; f) receiving the warning information from Step e) with the smart wristband unit; g) processing the warning information from Step e) with the smart wristband unit; and h) alerting a user of the processed warning information from Step g) with the smart wristband unit.

### BRIEF DESCRIPTION OF THE DRAWINGS

FIG. 1 is and illustration of a pedestrian and worker safety system 100.

FIG. 2 is an illustration of a communication unit 202 of an embodiment of a pedestrian and worker safety system 200.

FIG. 3 is an illustration of a smart wristband unit 102 of an embodiment of a pedestrian and worker safety system 300.

FIG. 4 is an illustration of a communication unit 202 of an embodiment of a pedestrian and worker safety system 400.

FIG. 5 is a flow chart illustrating a method for alerting an operator and the user 500 implemented in the pedestrian and worker safety system 100.

FIG. 6 illustrates a schematic block diagram of a conceptual computer system 600 used to implement some embodiments. For example, the system described with reference to the disclosure and Figures herein may be at least partially implemented using computer system 600.

### DETAILED DESCRIPTION OF THE EMBODIMENTS

The following is a detailed description of certain specific embodiments of the pedestrian and worker safety systems disclosed herein. In this description reference is made to the drawings.

In one aspect, disclosed herein is a pedestrian and worker safety system, comprising: a) at least one smart wristband unit; and b) one or more machines, vehicles and/or trains, each comprising i) a communication unit comprising a wireless transceiver capable of transmitting and/or receiving at least one warning information to/from at least one smart wristband unit; and ii) a warning display unit, wherein warning information is transmitted via wireless communication between one or more machines, vehicles and/or trains and at least one smart wristband unit, and wherein the at least one smart wristband unit comprises a vibration unit for alerting a user of warning information. Because the warning system does not rely solely on an audible alarm, the smart wristband unit 102 is particularly useful for users with a visual disability or a disability. Moreover, pedestrians and workers and operators of machines, vehicles and/or trains may be visually or audibly disadvantaged due to climate or job site conditions and in these situations the pedestrian and worker safety system could be advantageous.

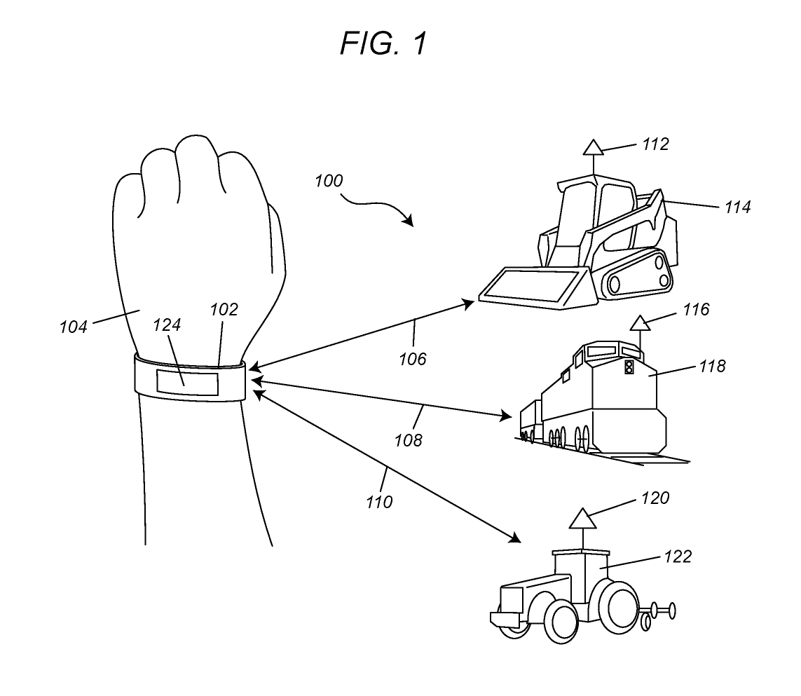

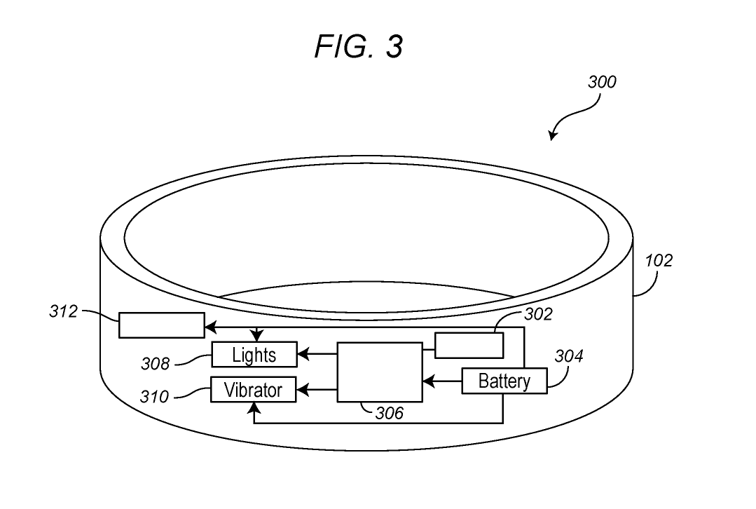

Turning to the drawings, FIGS. 1 and 3 illustrate a pedestrian and worker safety system 100 of the disclosure herein. As depicted, a smart wristband unit 102 of a user 104 is in wireless communication with the one or more machines 114, vehicles 122 and/or trains 118. The wireless communication of the pedestrian and worker safety system 100 with the one or more machines 114, vehicles 122 and/or trains 118 are capable of transmitting and/or receiving warning information 106, 108 and 110 via transceivers 112, 116 and 120, respectively. In some embodiments, the warning information is transmitted via wireless communication between one or more machines, vehicles and/or trains and at least one smart wristband unit using Bluetooth®, an RF transceiver, a Wi-Fi™ transceiver or other suitable means to transmit and receive short range data from each machines, vehicles and/or trains and the smart wristband unit.

FIG. 3 is an illustration of a smart wristband unit 102 of an embodiment of a pedestrian and worker safety system 300. In some embodiments, the at least one smart wristband unit comprises a processor 306 for processing warning information. In some embodiments, the at least one smart wristband unit comprises a rechargeable battery power source 304. Moreover, the smart wristband unit 102 can provide other alerts, such as audible alerts including tone patterns and synthesized or recorded voice messages, flashing lights, illumination of the display, etc. Varying levels of importance or priority can be processed in the smart wristband unit 102 or the user can modify the priority or response to the transmission. In one example, a life threatening hazard would activate higher levels of warning information, which may include a variety of loud audible siren warnings, recorded voice messages, audible messages stating the nature of the hazard, in conjunction with vibration sensations emitted in multiple strengths, while a non-life threatening warning could be restricted to non-audible alarms or audible alarms at lower volume. In some embodiments, the at least one smart wristband unit comprises a vibration unit 310 for alerting a user of warning information. Such determination may be made by the time of day, programmed by the user, or sensed by the smart wristband unit 102 based on user movement.

In some embodiments, the at least one smart wristband unit 102 comprises a liquid crystal display (LCD) 124 for displaying warning information. The screen display 124 is capable of being illuminated during upon receipt of warning information to aid the user in reading the message. Along with the basic alert warning, additional information or instructions that would be helpful can be included. For example, displaying the location of the machine 114, vehicle 122 and/or train 118 can assist the user to avoid walking towards the hazard. The content of the messages could be preprogrammed with additional instructions edited as needed on the device or from the source of the transmission. Additional information can also be extracted from the transmission and inserted when it is useful. In some embodiments, the at least one smart wristband unit comprises one or more lights 308 for displaying warning information. In some embodiments, the at least one smart wristband unit comprises one or speakers 312 for alerting a user of warning information. In some embodiments, the at least one smart wristband unit comprises an RF antenna for receiving warning information. In some embodiments, the at least one smart wristband unit comprises a wireless transceiver or antenna 302 for transmitting signals and/or receiving warning information.

In the present disclosure, warning information transmitted to pedestrians and workers via the safety system 100 refers to a type of hazardous condition that may harm users of the smart wristband unit 102 when one or more machines 114, vehicles 122 and/or trains 118 are in close proximity. In particular, local hazards may include an approaching machine 114, vehicle 122 and/or train 118 that could collide with one or more pedestrians and/or workers. Other harmful environments are contemplated, and they are within the scope of the present invention. Moreover, the proximity of the local hazards can be customized according to the various environments and needs of the implementation. The alternative embodiments including a variety of machines 114, vehicles 122 and/or trains 118 may depend on the construction, commercial, roadway and/or geographic areas where the pedestrian and worker safety system 100. The pedestrian and worker safety system 100 of FIG. 1 is intended to alert the users and to protect the users from harm with nearby and/or approaching machines 114, vehicles 122 and/or trains 118.

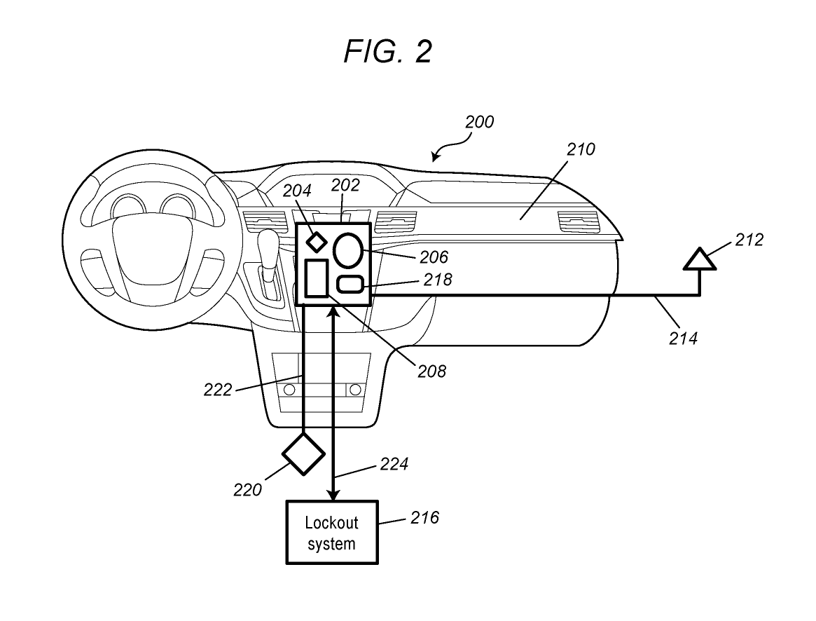

Turning to the drawings, FIG. 2 is an illustration of a communication unit 202 of an embodiment of a pedestrian and worker safety system 200 shown within a cab of a machine, vehicle or train 210. In some embodiments, the communication unit comprises a liquid crystal display (LCD) 208 for displaying warning information. In some embodiments, the communication unit comprises one or more lights 204 for displaying warning information. In some embodiments, the communication unit comprises one or speakers 206 for alerting a user of warning information. In some embodiments, the communication unit comprises a processor 216 for processing warning information. In some embodiments, the communication unit is powered by the machine's, vehicle's and/or train's power source 220 via power cable 222. In some embodiments, the pedestrian and worker safety system further comprises that a machine's, vehicle's and/or train's lockout system 216 is engaged based upon warning information via lockout system communication 224, which may be wired or wireless. The communication unit 202 employs a wireless transceiver 212 in electrical communication with the processor unit 216 and is capable of transmitting and/or receiving warning information to/from at least one smart wristband unit.

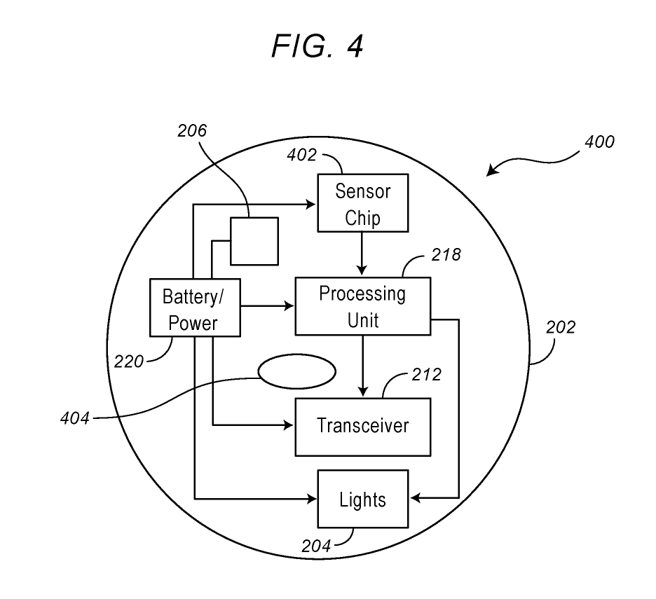

As depicted, FIG. 4 is an illustration of a communication unit 202 of an embodiment of a pedestrian and worker safety system 400. In some embodiments, the communication unit further comprises a processor unit 218 configured to store data in a system memory. In some embodiments, the communication unit comprises a computer-readable storage medium 404 storing executable computer program code for sending and/or receiving warning information to/from the at least one smart wristband unit. The communication unit 202 may use a sensor chip 402 for detecting users wearing smart wristband units of the disclosure herein.

In another aspect, disclosed herein is a method of improving pedestrian and worker safety comprising the pedestrian and worker safety system of claim 1, the method comprising: a) transmitting warning information from at least one smart wristband unit to at least one communication unit; b) receiving the warning information from step a) with the at least one communication unit; c) processing the received warning information from step b) with the at least one communication unit; d) transmitting warning information to an operator via a communication unit; e) transmitting warning information from the at least one communication unit to at least one smart wristband unit; f) receiving the warning information from Step e) with the smart wristband unit; g) processing the warning information from Step e) with the smart wristband unit; and h) alerting a user of the processed warning information from Step g) with the smart wristband unit.

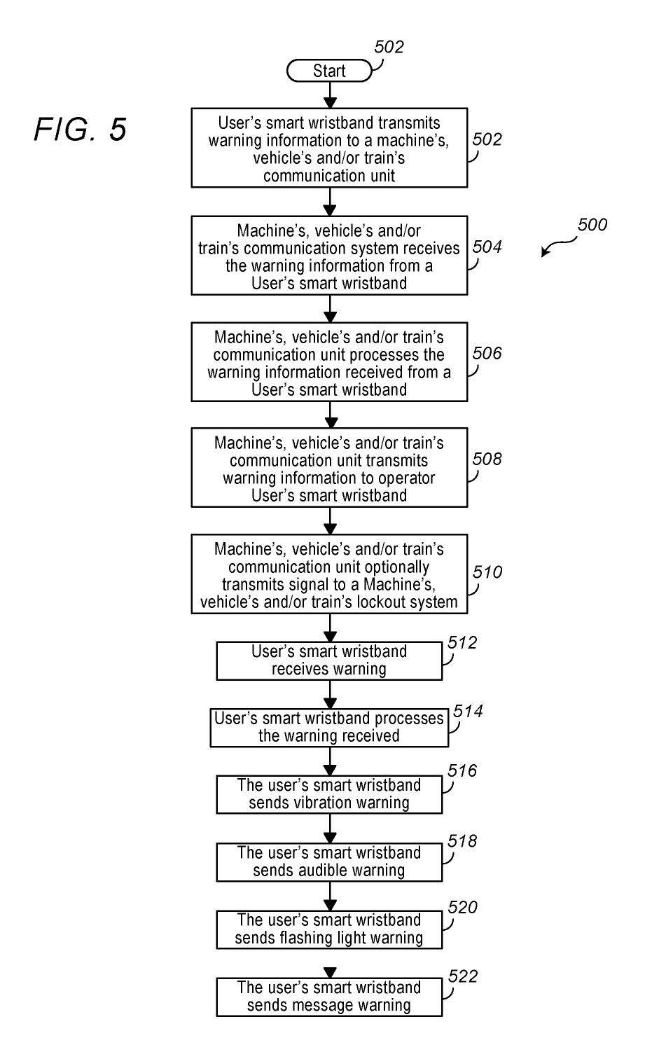

Referring to the drawings, FIG. 5 is a flow chart illustrating a method for alerting the user 500 implemented 502 in the pedestrian and worker safety system 100. In accordance with an aspect of the present disclosure, the user's smart wristband unit transmits warning information 502, which is received 504 by a machine's 114, vehicle's 122 and/or train's 118 communication unit 202. The machine's 114, vehicle's 122 and/or train's 118 communication unit 202 processes the warning information 506 received and transmits warning information 508 to an operator of the machine 114, vehicle 122 and/or train 118, and a user's smart wristband unit. Then, the user's smart wristband unit 102 of the present disclosure receives the warning information 512. The smart wristband unit 102 processes warning information 514. Next, the smart wristband unit 102 sends one or more warnings including but not limited to a vibration warning 516, audible warning 518, flashing light warning 520 and/or message warning 522. In this aspect, the smart wristband unit 102 of the present disclosure provides an appropriate or programmed alert, which may include vibration, audible, alarm, and information displayed on the device's screen. In some embodiments, the method of improving pedestrian and worker safety, wherein at least one of a braking system, an accelerator control unit, hydraulic system, and a steering control unit are at least one of disable and variably controlled by a machine's, vehicle's and/or train's lockout system 510 based upon a processed warning information 506 received from a user's smart wristband that is in close proximity. In certain situations, back up alarms on job sites continuously being triggered ON and OFF throughout the day and become back ground noise. Moreover, vehicle sensors only warn the operator of a user wearing the smart wristband that is in close proximity, which is dependent on the communication unit 202 is employed in a machine 114, vehicle 122 and/or train 118. However, the pedestrian and worker safety system disclosed herein will provide warning information of a person in close proximity and at the same time provide warning information to the person in danger.

### Computer System

Many of the processes and modules described above may be implemented as software processes that are specified as one or more sets of instructions recorded on a non-transitory storage medium. When these instructions are executed by one or more computational element(s) (e.g., microprocessors, microcontrollers, digital signal processors (DSPs), application-specific integrated circuits (ASICs), field programmable gate arrays (FPGAs), etc.) the instructions cause the computational element(s) to perform actions specified in the instructions.

In some embodiments, various processes and modules described above may be implemented completely using electronic circuitry that may include various sets of devices or elements (e.g., sensors, logic gates, analog to digital converters, digital to analog converters, comparators, etc.). Such circuitry may be adapted to perform functions and/or features that may be associated with various software elements described throughout.

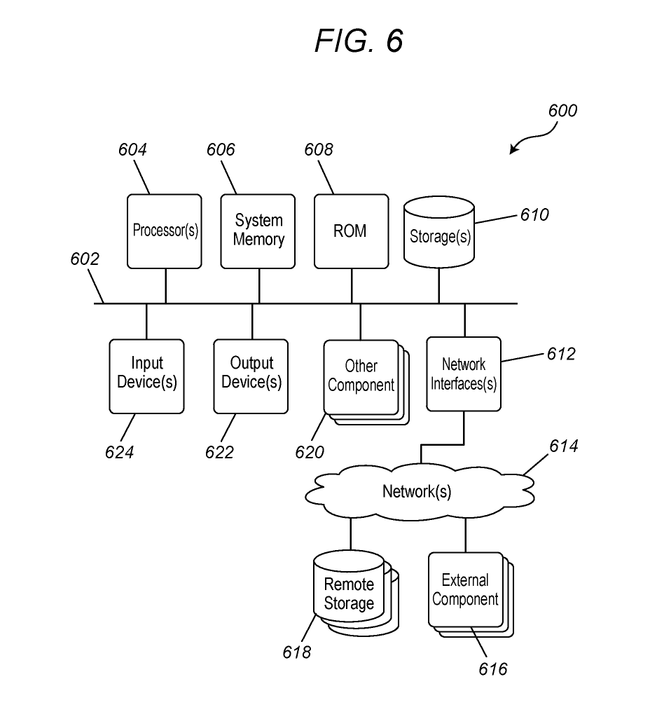

Referring to the drawings, FIG. 6 illustrates a schematic block diagram of a conceptual computer system 600 used to implement some embodiments. For example, the system described above in reference to FIGS. 1-5 may be at least partially implemented using all or a portion of computer system 600.

Computer system 600 may be implemented using various appropriate devices. For instance, the computer system may be implemented using one or more vehicle display units, personal computers (PCs), servers, mobile devices (e.g., a smartphone), tablet devices, and/or any other appropriate devices. The various devices may work alone (e.g., the computer system may be implemented as a vehicle display unit) or in conjunction (e.g., some components of the computer system may be provided by a vehicle display unit while other components may be provided by a tablet device).

As shown, computer system 600 may include at least one communication bus 602, one or more processors 604, a system memory 606, a read-only memory (ROM) 608, permanent storage devices 610, input devices 624, output devices 622, various other components 620 (e.g., a graphics processing unit), and one or more network interfaces 612 and may include a network 614, corresponding remote storage 618 and a corresponding external component 616.

Communication bus 602 represents all communication pathways among the elements of computer system 600. Such pathways may include wired, wireless, optical, and/or other appropriate communication pathways. For example, input devices 624 and/or output devices 622 may be coupled to the system 600 using a wireless connection protocol or system.

The processor 604 may, in order to execute the processes of some embodiments, retrieve instructions to execute and/or data to process from components such as system memory 606, ROM 608, and permanent storage device 610. Such instructions and data may be passed over bus 602.

System memory 606 may be a volatile read-and-write memory, such as a random access memory (RAM). The system memory may store some of the instructions and data that the processor uses at runtime. The sets of instructions and/or data used to implement some embodiments may be stored in the system memory 606, the permanent storage device 610, and/or the read-only memory 608. ROM 608 may store static data and instructions that may be used by processor 604 and/or other elements of the computer system.

Permanent storage device 610 may be a read-and-write memory device. The permanent storage device may be a non-volatile memory unit that stores instructions and data even when computer system 600 is off or unpowered. Computer system 600 may use a removable storage device and/or a remote storage device as the permanent storage device.

Input devices 624 may enable a user to communicate information to the computer system and/or manipulate various operations of the system. The input devices may include keyboards, cursor control devices, audio input devices and/or video input devices. Output devices 622 may include printers, displays, and/or audio devices. Some or all of the input and/or output devices may be wirelessly or optically connected to the computer system.

Other components 620 may perform various other functions. These functions may include performing specific functions (e.g., graphics processing, sound processing, etc.), providing storage, interfacing with external systems or components, etc.

Referring to FIG. 6, the computer system 600 may be coupled to one or more networks 614 through one or more network interfaces 612. For example, computer system 600 may be coupled to a web server on the Internet such that a web browser executing on computer system 600 may interact with the web server as a user interacts with an interface that operates in the web browser. Computer system 600 may be able to access one or more remote storages 618 and one or more external components 616 through the network interface 612 and network 614. The network interface(s) 612 may include one or more application programming interfaces (APIs) that may allow the computer system 600 to access remote systems and/or storages and also may allow remote systems and/or storages to access computer system 600 (or elements thereof).

As used in this specification and any claims of this application, the terms “computer”, “server”, “processor”, and “memory” all refer to electronic devices. These terms exclude people or groups of people. As used in this specification and any claims of this application, the term “non-transitory storage medium” is entirely restricted to tangible, physical objects that store information in a form that is readable by electronic devices. These terms exclude any wireless or other ephemeral signals.

It should be recognized by one of ordinary skill in the art that any or all of the components of computer system 600 may be used in conjunction with some embodiments. Moreover, one of ordinary skill in the art will appreciate that many other system configurations may also be used in conjunction with some embodiments or components of some embodiments.

In addition, while the examples shown may illustrate many individual modules as separate elements, one of ordinary skill in the art would recognize that these modules may be combined into a single functional block or element. One of ordinary skill in the art would also recognize that a single module may be divided into multiple modules.

### Definitions

For the purposes of this specification and appended claims, unless otherwise indicated, all numbers expressing quantities, percentages or proportions, and other numerical values used in the specification and claims, are to be understood as being modified in all instances by the term “about.” Accordingly, unless indicated to the contrary, the numerical parameters set forth in the following specification and attached claims are approximations that can vary depending upon the desired properties sought to be obtained. It is noted that, as used in this specification and the appended claims, the singular forms “a,” “an,” and “the,” include plural references unless expressly and unequivocally limited to one referent. As used herein, the term “include” and its grammatical variants are intended to be non-limiting, such that recitation of items in a list is not to the exclusion of other like items that can be substituted or added to the listed items. As used herein, the term “comprising” means including elements or steps that are identified following that term, but any such elements or steps are not exhaustive, and an embodiment can include other elements or steps.

The term “lockout system”, refers to any system of a machine, vehicle or train that has an emergency shutdown system, emergency control system and/or emergency override system. This includes OEM lockout software and components and aftermarket lockout software and components.

The term “machine” refers to forklifts, front loaders, Excavators, SkidSteers, Backhoes, Bulldozer, Snowcat, Track skidder, Tractor, Military engineering vehicles, Backhoe loader, Backhoe, Construction & mining tractor, Articulated hauler, Articulated truck, Feller buncher, Harvester, Skidder, Track harvester, Pipelayer, Scraper, Loader, Skip loader, Wheel loader, Cherry picker, Crane, Knuckleboom loader (trailer mount), Telescopic handlers, Asphalt paver, Paver, Slipform paver, Drilling machine, Pile driver, Rotary tiller, etc.

The term “vehicle”, refers to trucks, agricultural vehicles, buses, job site service vehicles, emergency vehicles, etc.

As will be understood by one skilled in the art, for any and all purposes, particularly in terms of providing a written description, all ranges disclosed herein also encompass any and all possible subranges and combinations of subranges thereof Any listed range can be easily recognized as sufficiently describing and enabling the same range being broken down into at least equal halves, thirds, quarters, fifths, tenths, etc. As a non-limiting example, each range discussed herein can be readily broken down into a lower third, middle third and upper third, etc. As will also be understood by one skilled in the art all language such as “up to,” “at least,” “greater than,” “less than,” and the like, include the number recited and refer to ranges which can be subsequently broken down into subranges as discussed above. Finally, as will be understood by one skilled in the art, a range includes each individual member.

While certain embodiments have been illustrated and described, it should be understood that changes and modifications can be made therein in accordance with ordinary skill in the art without departing from the technology in its broader aspects as defined in the following claims.

The present disclosure is not to be limited in terms of the particular embodiments described in this application. Many modifications and variations can be made without departing from its spirit and scope, as will be apparent to those skilled in the art. Functionally equivalent methods and devices within the scope of the disclosure, in addition to those enumerated herein, will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is to be understood that this disclosure is not limited to particular methods or devices, which can of course vary. It is also to be understood that the terminology used herein is for the purpose of describing particular embodiments only, and is not intended to be limiting.

All publications, patent applications, issued patents, and other documents referred to in this specification are herein incorporated by reference as if each individual publication, patent application, issued patent, or other document was specifically and individually indicated to be incorporated by reference in its entirety. Definitions that are contained in text incorporated by reference are excluded to the extent that they contradict definitions in this disclosure.

1. A pedestrian and worker safety system, comprising:
a) at least one smart wristband unit; and
b) one or more machines, vehicles and/or trains, each comprising
i. a communication unit comprising a wireless transceiver capable of transmitting and/or receiving at least one warning information to/from the at least one smart wristband unit; and
ii. a warning display unit,
wherein the warning information is transmitted via wireless communication between the one or more machines, vehicles and/or trains and at least one smart wristband unit, and
wherein said at least one smart wristband unit is configured to initiate the transmission from the at least one smart wristband unit to the a communication unit and cause the communication unit to transmit the warning information to an operator of the one or more machines, vehicles and/or trains, each comprising and the wearer of the at least one smart wristband unit.

2. The pedestrian and worker safety system of claim 1, wherein the at least one smart wristband unit comprises a liquid crystal display (LCD) for displaying the warning information.

3. The pedestrian and worker safety system of claim 1, wherein the at least one smart wristband unit comprises one or more lights for displaying the warning information.

4. The pedestrian and worker safety system of claim 1, wherein the at least one smart wristband unit comprises one or speakers for alerting a user of the warning information.

5. The pedestrian and worker safety system of claim 1, wherein the at least one smart wristband unit comprises a vibration unit for alerting a user of the warning information.

6. The pedestrian and worker safety system of claim 1, wherein the at least one smart wristband unit comprises an RF antenna for receiving the warning information.

7. The pedestrian and worker safety system of claim 1, wherein the at least one smart wristband unit comprises a wireless transceiver for transmitting and/or receiving the warning information.

8. The pedestrian and worker safety system of claim 1, wherein the at least one smart wristband unit comprises a processor for processing the warning information.

9. The pedestrian and worker safety system of claim 1, wherein the at least one smart wristband unit comprises a rechargeable battery power source.

10. The pedestrian and worker safety system of claim 1, wherein the communication unit comprises a liquid crystal display (LCD) for displaying the warning information.

11. The pedestrian and worker safety system of claim 1, wherein the communication unit comprises one or more lights for displaying the warning information.

12. The pedestrian and worker safety system of claim 1, wherein the communication unit comprises one or speakers for alerting a user of the warning information.

13. The pedestrian and worker safety system of claim 1, wherein the communication unit comprises a processor for processing the warning information.

14. The pedestrian and worker safety system of claim 1, wherein the communication unit further comprises a processor unit configured to store data in a system memory.

15. The pedestrian and worker safety system of claim 1, wherein the communication unit comprises a computer-readable storage medium storing executable computer program code for sending and/or receiving the warning information to/from the at least one smart wristband unit.

16. The pedestrian and worker safety system of claim 1, wherein the communication unit is powered by the machine's, vehicle's and/or train's power source.

17. The pedestrian and worker safety system of claim 1, further comprising that a machine's, vehicle's and/or train's lockout system is engaged based upon the warning information.

18. A method of improving pedestrian and worker safety comprising the pedestrian and worker safety system of claim 1, the method comprising:
a) initiating the transmission of the warning information from at least one smart wristband unit to the at least one communication unit;
b) receiving the the warning information from step a) with the at least one communication unit;
c) processing the received the warning information from step b) with the at least one communication unit;
d) transmitting the warning information to an operator via a communication unit;
e) transmitting the warning information from the at least one communication unit to at least one smart wristband unit;
f) receiving the warning information from Step e) with the smart wristband unit;
g) processing the warning information from Step e) with the smart wristband unit; and
h) alerting a user of the processed warning information from Step g) with the smart wristband unit.

19. The method of improving pedestrian and worker safety of claim 19, wherein at least one of a braking system, an accelerator control unit, hydraulic system, and a steering control unit are at least one of disable and variably controlled by a machine's, vehicle's and/or train's lockout system based upon the warning information.
